(19) United States
(12) Patent Application Publication
(10) Pub. No.: US 2025/0125394 A1
(43) Pub. Date: Apr. 17, 2025

(54) HIGH-TEMPERATURE POLYMER ELECTROLYTE MEMBRANE FUEL CELL AND METHOD OF MANUFACTURING THE SAME

(71) Applicants: Hyundai Motor Company, Seoul (KR); Kia Corporation, Seoul (KR); Research & Business Foundation Sungkyunkwan University, Suwon (KR)

(72) Inventors: Won Jae Choi, Seoul (KR); Songi Oh, Suwon (KR); Da Hee Kwak, Suwon (KR); Hyoun Myung Park, Incheon (KR); Sung Hee Shin, Incheon (KR); Jee Youn Hwang, Seoul (KR); Ah Hyeon Park, Suwon (KR); Kyung Su Kim, Seoul (KR); Ji Yun Kim, Ansan (KR); Seong Min Cho, Suwon (KR); Changsik Song, Seoul (KR)

(21) Appl. No.: 18/732,719

(22) Filed: Jun. 4, 2024

(30) Foreign Application Priority Data
Oct. 11, 2023 (KR) 10-2023-0134771

(51) Int. Cl. H01M 8/1027; H01M 4/90; H01M 8/1004

(52) U.S. Cl. CPC H01M 8/1027; H01M 4/9058; H01M 8/1004

(57) ABSTRACT

Disclosed is a high-temperature polymer electrolyte membrane fuel cell, in which electrodes of the fuel cell include a polymer containing a phosphoric acid group and a binaphthyl group, thereby preventing phosphoric acid poisoning of a catalyst due to strong interaction with phosphoric acid and porosity and increasing electrochemical performance.

### CROSS-REFERENCE TO RELATED APPLICATION

This application claims, under 35 U.S.C. § 119(a), the benefit of Korean Patent Application No. 10-2023-0134771, filed on Oct. 11, 2023, the entire contents of which are incorporated herein by reference.

### BACKGROUND

### Technical Field

The present disclosure relates to a high-temperature polymer electrolyte membrane fuel cell and a method of manufacturing the same.

### Background

High-temperature polymer electrolyte membrane fuel cells (HT PEMFCs) typically operate at temperatures of 120° C. to 200° C. Currently, high-temperature polymer electrolyte membrane fuel cells have problems, such as leakage of phosphoric acid from the polymer membrane during operation, resulting in decreased cation conductivity of the polymer membrane, and deteriorated electrochemical performance due to phosphoric acid poisoning of the catalyst.

However, high-temperature polymer electrolyte membrane fuel cells have many advantages such as no need for CO removal devices, humidifiers, and condensate treatment devices, CO resistance, high catalytic activity, and the like, compared to low-temperature fuel cells. Therefore, development of new materials for high-temperature polymer electrolyte membrane fuel cells is required.

### SUMMARY

The present disclosure has been made keeping in mind the problems encountered in the related art, and is intended to provide manufacture of electrodes using a polymer material, thus decreasing leakage of phosphoric acid and phosphoric acid poisoning, thereby improving performance of high-temperature polymer electrolyte membrane fuel cells.

The objects of the present disclosure are not limited to the foregoing. The objects of the present disclosure will be able to be clearly understood through the following description and to be realized by the means described in the claims and combinations thereof.

The present disclosure provides a high-temperature polymer electrolyte membrane fuel cell, including an electrolyte membrane, and electrodes including a cathode disposed on one side of the electrolyte membrane and an anode disposed on another side of the electrolyte membrane, in which the electrodes may include a catalyst, an ionomer, and a polymer having a binaphthyl functional group.

As referred to herein, a binaphthyl functional group is a moiety that comprises at least two optionally substituted naphthyl groups. For example, the multiple naphthyl groups may be covalently linked by one or more bonds. In aspects, two or more naphthyl groups may be linked by an interposing non-aromatic ring (e.g. a 5 or 6-membered ring), where atoms of each of two naphthyl groups are ring members. The naphthyl groups are optionally substituted and each or one of the naphthyl groups suitably may include one or more ring substituents such as halo (F, Cl, Br, I), optionally substituted alkyl including C₁₋₁₂alkyl, nitro, cyano, optionally substituted alkoxy including C₁₋₁₂alkoxy, carbocyclic aryl e.g. phenyl, naphthyl, and the like.

In aspects, a binaphthyl functional group may comprise a structure of the following Formula (A):

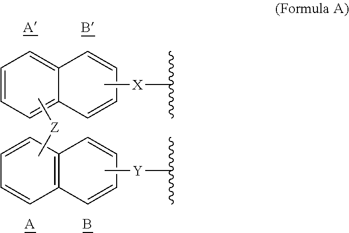

wherein Formula (A), Z is an optional covalent linker between the depicted naphthyl groups and may provide one or more covalent bonds between naphthyl groups. Z suitably may be a linker that contains one or more carbon atoms, such as 1 to 10 carbon atoms or 1, 2, 3, 4, 5 or 6 carbon atoms. The depicted X and Y groups are linkers that can covalently linked to the polymer structure e.g. the polymer backbone linkage. The X and Y groups also may form a fused ring system with the depicted naphthyl groups. X and Y groups may comprise one or more of the same as described for Z or for T and U in the below Formula (B)>Each of the respective units A, B, A′ and B′ of the naphthyl groups may be optionally at one or more available ring positions by groups such as halo (F, Cl, Br, I), optionally substituted alkyl including C₁₋₁₂alkyl, nitro, cyano, optionally substituted alkoxy including C₁₋₁₂alkoxy, carbocyclic aryl e.g. phenyl, naphthyl, and the like.

In preferred aspects, a binaphthyl functional group may comprise a structure of the following Formula (B)

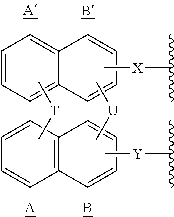

wherein Formula (A), Z is a covalent linker between the depicted naphthyl groups and may provide one or more covalent bonds between naphthyl groups. T and U are each linkers that contains one or more carbon atoms, such as 1 to 10 carbon atoms or 1, 2, 3, 4, 5 or 6 carbon atoms, or 1, 2 or 3 carbon atoms. In preferred systems, T and U together with the naphthyl rings form a 3-ring fused system with a non-aromatic ring (e.g. 5 or 6 ring members with 2 of the ring members being from rings A′ and/or B′ and two of the ring members being from A and/or B) being interposed being the two naphthyl ring. In certain preferred systems where T and U together with the naphthyl rings form a 3-ring fused system at least one ring member (e.g. of the linker U or T) includes a cation exchange group (exemplary cation change groups including a sulfonic acid group, a carboxyl group, a phosphoric acid group, an imide group, a sulfonimide group, a sulfonamide group, a hydroxyl group). The depicted X and Y groups are linkers that can covalently linked to the polymer structure e.g. the polymer backbone linkage. Exemplary X and Y groups may comprise one or more hetero atoms (O, N or S), optional substituted C1-10alkylene, (i.e. —(CH₂)ₙ— where n is 1 to 10)-carbocyclic aryl such as optionally substitute phenyl or naphthyl and the like. Each of the respective units A, B, A′ and B′ of the naphthyl groups may be optionally at one or more available ring positions by groups such as halo (F, Cl, Br, I), optionally substituted alkyl including C₁₋₁₂alkyl, nitro, cyano, optionally substituted alkoxy including C₁₋₁₂alkoxy, carbocyclic aryl e.g. phenyl, naphthyl, and the like.

In preferred aspects, a binaphthyl functional group may comprise a structure of the following Formula 1.

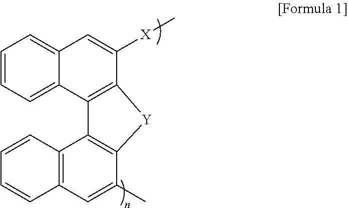

Here, X includes a C6-C20 aromatic functional group, Y includes a cation exchange group, and n is an integer of 5 to 1000.

The aromatic functional group may be represented by Chemical Formula 2 below.

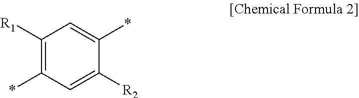

Here, * represents a connection site.

R₁ and R₂ each independently include a substituted or unsubstituted C1-C20 alkoxy group or perfluoroalkoxy group.

The cation exchange group may include at least one selected from the group consisting of a sulfonic acid group, a carboxyl group, a phosphoric acid group, an imide group, a sulfonimide group, a sulfonamide group, a hydroxyl group, and combinations thereof.

The cation exchange group may be a phosphoric acid group.

The polymer may be represented by Chemical Formula 3 below.

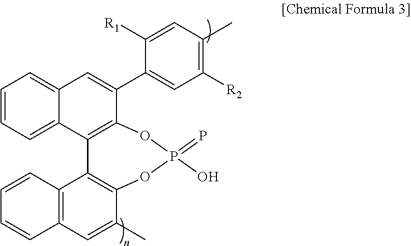

Here, R₁ and R₂ each independently include a substituted or unsubstituted C1-C20 alkoxy group or perfluoroalkoxy group, and n is an integer of 5 to 1000.

The polymer may be attached to the surface of the catalyst.

The catalyst may comprise at least one selected from the group consisting of platinum, palladium, cobalt, gold, ruthenium, tin, molybdenum, rhodium, iridium, bismuth, copper, yttrium, and chromium. The catalyst may be platinum.

The ionomer may comprise at least one selected from the group consisting of a perfluorosulfonic acid polymer, a hydrocarbon-based polymer, and a polybenzimidazole polymer.

In some embodiments, a high-temperature polymer electrolyte membrane fuel cell may include an electrode. The electrode may comprise a catalyst and a polymer attached to a surface of the catalyst, wherein the polymer is represented by Chemical Formula 2 below:

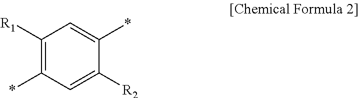

in Chemical Formula 2, * may represent a connection site, and R1 and R2 each independently comprise a substituted or unsubstituted C1-C20 alkoxy group or perfluoroalkoxy group, and
Y may comprise at least one selected from the group consisting of a sulfonic acid group, a carboxyl group, a phosphoric acid group, an imide group, a sulfonimide group, a sulfonamide group, a hydroxyl group, and combinations thereof.

The catalyst may comprise at least one selected from the group consisting of platinum, palladium, cobalt, gold, ruthenium, tin, molybdenum, rhodium, iridium, bismuth, copper, yttrium, and chromium.

In addition, the present disclosure provides a method of manufacturing a high-temperature polymer electrolyte membrane fuel cell, including preparing a polymer having a binaphthyl functional group, manufacturing electrodes including a catalyst, an ionomer, and the polymer, and stacking the electrodes on respective opposite sides of an electrolyte membrane.

Here, preparing the polymer may include preparing compound B represented by Chemical Formula 5 below by subjecting compound A represented by Chemical Formula 4 below to Suzuki-Miyaura reaction, preparing compound C represented by Chemical Formula 6 below by subjecting compound B to demethylation reaction, and preparing a polymer represented by Chemical Formula 7 below by subjecting compound C to nucleophilic substitution reaction.

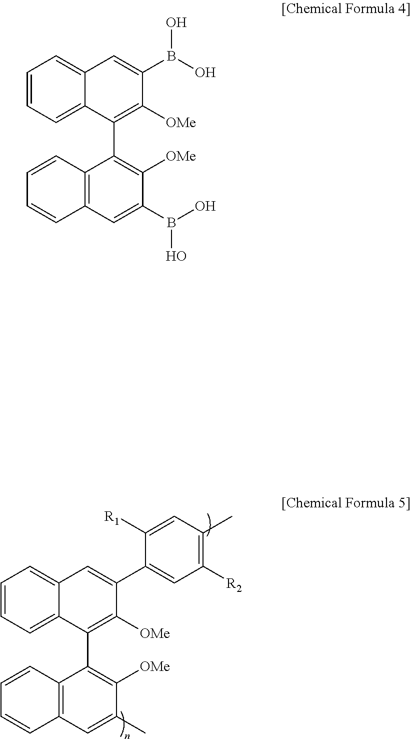

Here, R₁ and R₂ each independently include a substituted or unsubstituted C1-C20 alkoxy group or perfluoroalkoxy group, and n is an integer from 5 to 1000.

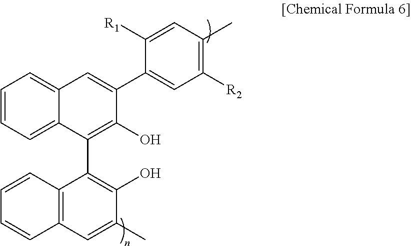

Here, R₁ and R₂ each independently include a substituted or unsubstituted C1-C20 alkoxy group or perfluoroalkoxy group, and n is an integer of 5 to 1000.

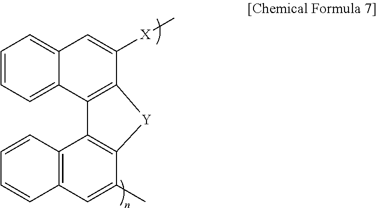

Here, X includes a C6-C20 aromatic functional group, Y includes a cation exchange group, and n is an integer of 5 to 1000.

In the Suzuki-Miyaura reaction, compound A reacts with 2,5-dialkoxy-1,4-dibromobenzene to result in compound B.

In the nucleophilic substitution reaction, compound C reacts with phosphoryl chloride (POCl₃) to result in the polymer represented by Chemical Formula 7.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows a high-temperature polymer electrolyte membrane fuel cell according to the present disclosure;

FIG. 2 shows results of a TGA (thermogravimetric analysis) of Preparation Example according to the present disclosure; and

FIG. 3 shows oxygen reduction reaction (ORR) activity of Example and Comparative Example according to the present disclosure.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

The term “ionomer” as used herein refers to a polymeric material or resin that includes ionized groups attached (e.g. covalently bonded) to the backbone of the polymer as pendant groups. Preferably, such ionized groups may be functionalized to have ionic characteristics, e.g., cationic or anionic.

The ionomer may suitably include one or more polymers selected from the group consisting of a fluoro-based polymer, a perfluorosulfone-based polymer, a benzimidazole-based polymer, a polyimide-based polymer, a polyetherimide-based polymer, a polyphenylene sulfide-based polymer, a polysulfone-based polymer, a polyethersulfone-based polymer, a polyetherketone-based polymer, a polyether-etherketone-based polymer, a polyphenylquinoxaline-based polymer and a polystyrene-based polymer.

The term “filler” as used herein refers to a material added to a matrix or an admixture to improve properties but not to react or be reactive with any other compounds or chemicals in a surrounding matrix or admixture. The filler may be in a form of particles, fibers, or resin, and preferably, the filler may be particles.

The term “binder”, as used herein, refers to a resin or a polymeric material that can be polymerized or cured to form a polymeric matrix. The binder may be cured (polymerized) or partially cured upon curing process such as heating, UV radiation, electron beaming, chemical polymerization using additives and the like. Preferably, the binder of the present invention may contain polyamic acid that can be polymerized into polyimide upon heating. Preferably, the binder according to the present invention generally refers to a polyimide binder.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

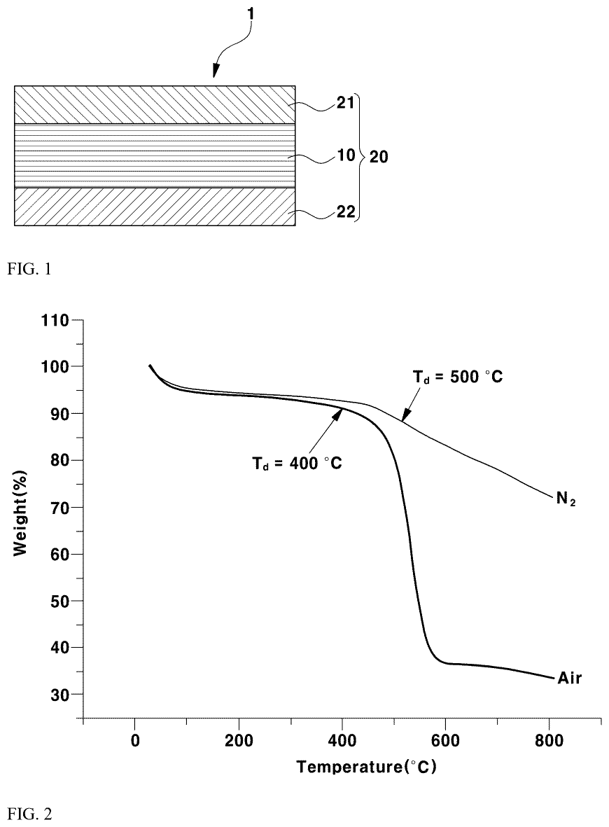

FIG. 1 shows a high-temperature polymer electrolyte membrane fuel cell according to the present disclosure. The high-temperature polymer electrolyte membrane fuel cell 1 may include an electrolyte membrane 10, and electrodes 20 including a cathode 21 disposed on one side of the electrolyte membrane 10 and an anode 22 disposed on another side of the electrolyte membrane 10.

The electrodes 20 may include a catalyst, an ionomer, and a polymer. Specifically, the cathode 21 and/or the anode 22 may include the catalyst, the ionomer, and the polymer.

The catalyst may include at least one selected from the group consisting of platinum, palladium, cobalt, gold, ruthenium, tin, molybdenum, rhodium, iridium, bismuth, copper, yttrium, and chromium, and particularly may include platinum and an alloy thereof.

The ionomer may include at least one selected from the group consisting of a perfluorosulfonic acid polymer, a hydrocarbon-based polymer, and a polybenzimidazole polymer.

Currently, commercial electrodes for high-temperature polymer electrolyte membrane fuel cells have the problem of deteriorated catalytic performance and durability by activity loss due to poisoning of the electrochemical catalyst. Therefore, it is necessary to introduce an anti-poisoning adsorption material on the catalyst surface that prevents adsorption of poisoning materials and enables permeation of ions and gases. In order to solve this problem, the electrodes 20 of the present disclosure may include a polymer that strongly adsorbs to the catalyst surface and has resistance to poisoning materials.

When the polymer is introduced as a single molecule, it is likely to leak to the outside along with fuel or electrolyte. On the other hand, in a situation where fuel (hydrogen/air), electrolyte (phosphoric acid), and reaction product (water) continuously enter and exit the system, when a polymer having a large size is provided, leakage of materials may be minimized.

Moreover, molecular weight is a factor that may have an influence on the access of oxygen by affecting crystallinity, density, etc. of the polymer. Since the polymer is provided, physical properties of the material may be controlled by adjusting molecular weight thereof. A high molecular weight may result in high crystallinity, low gas permeation, and high oxygen permeation.

The polymer may include a polymer having a binaphthyl functional group.

The polymer is effective at attaining porosity in electrodes and preventing phosphoric acid poisoning of the catalyst by introduction of binaphthyl having, for example, a tweezer-like structure. Such a structure (e.g. as described as tweezer like) may be formed by a non-aromatic ring that comprises ring atoms (e.g. 2 naphthyl ring atoms of each of the two naphthyl groups) of each of two naphthyl moieties of a binaphthyl functional group and a cation exchange group (e.g. Y in Formula I above).

The polymer may be represented by Chemical Formula 1 below.

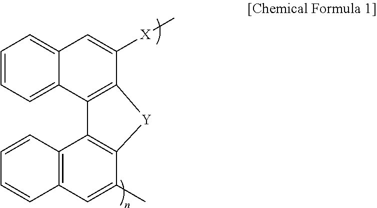

In Chemical Formula 1, X includes a C6-C20 aromatic functional group, Y includes a cation exchange group, and n is an integer of 5 to 1000.

Only when n satisfies the above range may it have a form in which chemical properties and physical properties based on molecular weight work together.

The aromatic functional group may be represented by Chemical Formula 2 below.

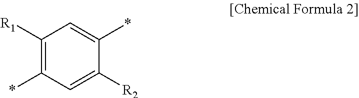

In Chemical Formula 2, * represents the connection site.

In Chemical Formula 2, R₁ and R₂ each independently include a substituted or unsubstituted C1-C20 alkoxy group or perfluoroalkoxy group.

The polymer is advantageously able to control physical properties such as hydrophobicity, porosity, molecular density, etc. through various R group changes, making it easy to form a triple-phase boundary and optimize oxygen permeation.

The cation exchange group may include at least one selected from the group consisting of a sulfonic acid group, a carboxyl group, a phosphoric acid group, an imide group, a sulfonimide group, a sulfonamide group, a hydroxyl group, and combinations thereof, and particularly may include a phosphoric acid group.

Introduction of a phosphoric acid group into the polymer has the effect of improving proton conductivity and facilitating the formation of hydrophilic channels.

An appropriate amount of phosphoric acid electrolyte is present within the electrodes, and efficient distribution of the electrolyte is capable of maximizing conductivity. The polymer according to the present disclosure has both binaphthyl and phosphoric acid functional groups, and thus may have phosphoric acid as a proton carrier nearby or may act as a proton carrier by itself, and furthermore, the tweezer-like structure thereof may prevent excessive access of phosphoric acid, allowing oxygen to sufficiently access the catalyst surface to some extent.

The polymer may be represented by Chemical Formula 3 below.

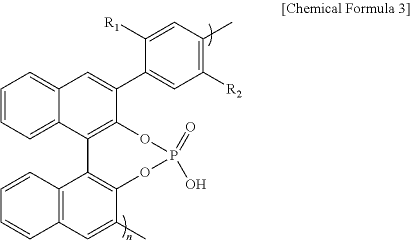

In Chemical Formula 3, R₁ and R₂ each independently include a substituted or unsubstituted C1-C20 alkoxy group or perfluoroalkoxy group, and n is an integer from 5 to 1000.

The polymer may be attached to the surface of the catalyst.

The polymer according to the present disclosure is electrochemically inactive and is capable of trapping molecules, thus suppressing phosphate poisoning of the surface of the platinum catalyst.

The electrolyte membrane 10 may include the polymer in an amount of about 50 wt % to 99 wt %, about 60 wt % to 90 wt %, or about 70 wt % to 90 wt %. The remainder thereof may be additives such as binders, fillers, etc.

A method of manufacturing the high-temperature polymer electrolyte membrane fuel cell may include preparing a polymer having a binaphthyl functional group, obtaining an electrolyte membrane including the polymer, and forming a cathode on one side of the electrolyte membrane and forming an anode on the remaining side of the electrolyte membrane.

Specifically, preparing the polymer may include preparing compound B represented by Chemical Formula 5 below by subjecting compound A represented by Chemical Formula 4 below to Suzuki-Miyaura reaction, preparing compound C represented by Chemical Formula 6 below by subjecting compound B to demethylation reaction, and preparing a polymer represented by Chemical Formula 7 below by subjecting compound C to nucleophilic substitution reaction.

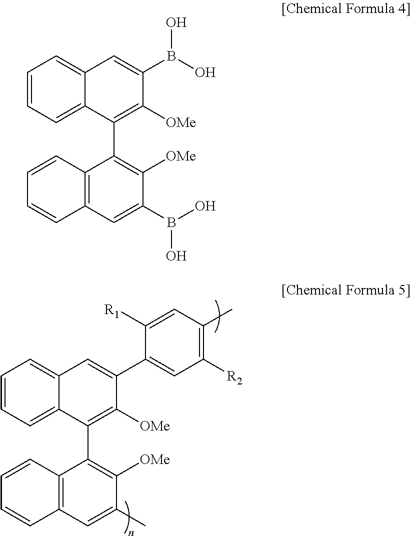

In Chemical Formula 5, R₁ and R₂ each independently include a substituted or unsubstituted C1-C20 alkoxy group or perfluoroalkoxy group, and n is an integer from 5 to 1000.

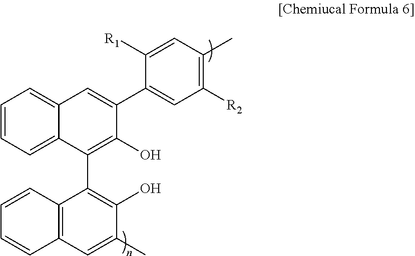

In Chemical Formula 6, R₁ and R₂ each independently include a substituted or unsubstituted C1-C20 alkoxy group or perfluoroalkoxy group, and n is an integer from 5 to 1000.

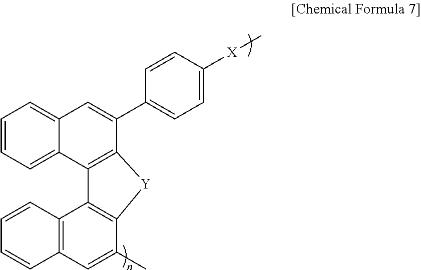

In Chemical Formula 7, X includes a C6-C20 aromatic functional group, Y includes a cation exchange group, and n is an integer of 5 to 1000.

In Suzuki-Miyaura reaction, compound A represented by Chemical Formula 4 is allowed to react with 2,5-dialkoxy-1,4-dibromobenzene. Specifically, 3,3′-bis(dihydroxyborane)-2,2′-dimethoxy-1,1′-binaphthyl and 2,5-dialkoxy-1,4-dibromobenzene are allowed to react with 10 mol % Pd(PPh₃)₄, Ba(OH)₂·H₂O, 4-dioxane, and H₂O, synthesizing compound B represented by Chemical Formula 5, which is a binaphthyl polymer containing a methoxy group.

In demethylation reaction, the methyl group of compound A is removed and a hydroxyl group is added. Specifically, compound C represented by Chemical Formula 6 may be prepared by reaction with BBr₃ and dichloromethane (DCM) for 3 to 5 hours.

In nucleophilic substitution reaction, compound C is allowed to react with phosphoryl chloride (POCl₃) so that the polymer contains a phosphoric acid group. Specifically, the polymer represented by Chemical Formula 7 may be prepared by allowing compound B to react with POCl₃, pyridine, and H₂O.

The polymer may contain a phosphoric acid group and may be represented by Chemical Formula 9 below.

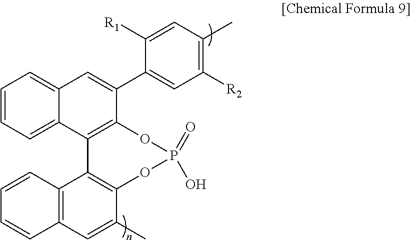

In Chemical Formula 9, R₁ and R₂ each independently include a substituted or unsubstituted C1-C20 alkoxy group or perfluoroalkoxy group, and n is an integer from 5 to 1000.

Scheme 1 below shows reaction for preparing a polymer according to an exemplary embodiment of the present disclosure.

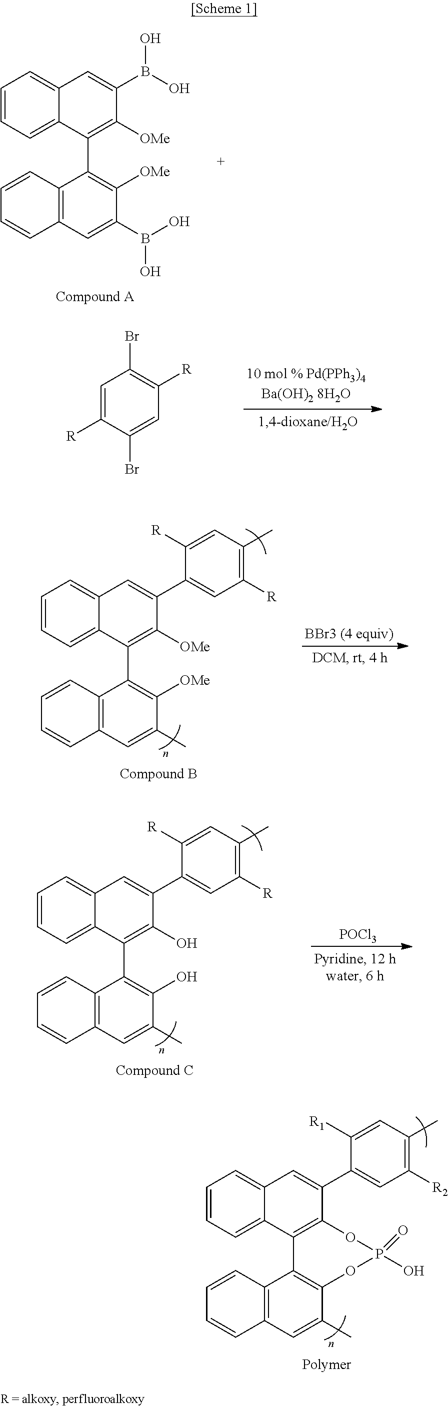

The polymer according to the present disclosure is prepared through a relatively easy and simple synthesis route with few side reactions as described above and is thus effective for commercialization, mass production, and economic efficiency. Moreover, the polymer contains a phosphoric acid group and a binaphthyl group, thereby preventing phosphoric acid poisoning of the catalyst due to strong interaction with phosphoric acid and porosity and increasing electrochemical performance.

A better understanding of the present disclosure may be obtained through the following examples. However, these examples are not to be construed as limiting the technical spirit of the present disclosure.

### Preparation Example

1 equivalent of 3,3′-bis(dihydroxyborane)-2,2′-dimethoxy-1,1′-binaphthyl, 1 equivalent of 2,5-dialkoxy-1,4-dibromobenzene, 10 mol % of Pd(PPh₃)₄, and 3 equivalents of Ba(OH)₂· H₂O were mixed with 1,4-dioxane and H₂O (0.25 M) and stirred at 90° C. for 12 hours. After removing the solvent from the reaction solution under reduced pressure, 4 equivalents of BBr₃ and dichloromethane (0.25 M) were added thereto, and dimethylation reaction was carried out at room temperature for 4 hours. Thereafter, 2 equivalents of POCl₃ and pyridine (0.25 M) were added to the reaction material and stirred at room temperature. After 12 hours, distilled water (1.0 M) was added thereto, followed by reaction for 6 hours, thereby preparing a polymer represented by the following chemical formula.

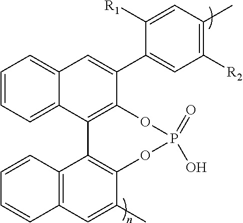

Here, R₁ and R₂ each independently include a substituted or unsubstituted C1-C20 alkoxy group or perfluoroalkoxy group, and n is an integer of 5 to 1000.

### Example

Electrodes were manufactured by adding 10 mg of 50 wt % TKK Pt/C (TEC10E50E loading: 20 μg/cm²) as a catalyst, IPA (isopropyl alcohol) and DIW as solvents, a perfluorosulfonic acid polymer as an ionomer, and 1 mg of the polymer prepared according to Preparation Example.

### Comparative Example

Electrodes were manufactured in the same manner as in Example, with the exception that no polymer was added.

### Test Example 1: Confirmation of Thermal Stability

In order to confirm thermal stability of the polymer prepared in Preparation Example, TGA (thermogravimetric analysis) was performed under nitrogen and air conditions. Here, the temperature at which 5% weight loss from the initial weight occurred was represented as Td.

FIG. 2 shows results of TGA of Example 1 according to the present disclosure. Referring thereto, the decomposition temperature was measured to be 500° C. under nitrogen conditions and to be 400° C. under air conditions, which was evaluated to be much higher than the typical decomposition temperature range of 150 to 200° C. for medium/high-temperature polymer electrolyte membrane fuel cells, confirming that the polymer according to the present disclosure has excellent thermal stability.

### Test Example 2: Confirmation of Anti-Poisoning Effect

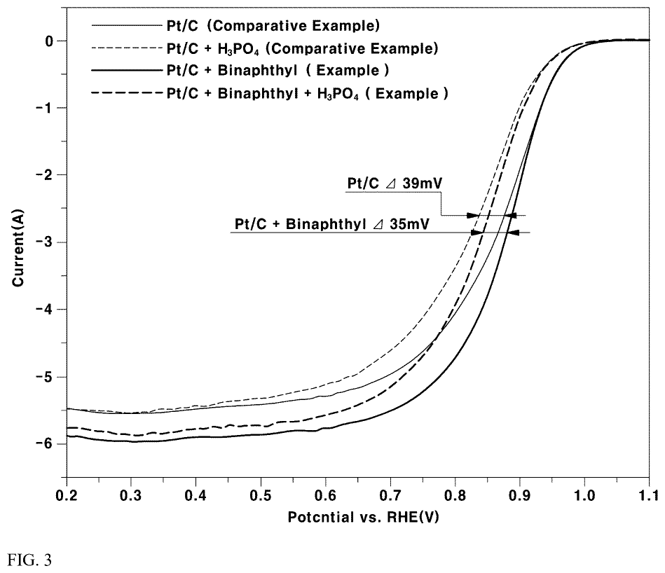

In order to confirm the anti-poisoning effect of an intrinsic microporous polymer, electrodes of Example and Comparative Example were manufactured. The ORR (oxygen reduction reaction) activity of the electrodes of Example and Comparative Example was measured under conditions of O₂-saturated 0.1 M HClO₄ and O₂-saturated 0.1 M HClO₄+0.05 M phosphoric acid. The results thereof are shown in Table 1 below and FIG. 3.

TABLE 1

| Classification | ΔMA (%) | ΔE_{1/2} (mV) |
|---|---|---|
| Comparative Example | 58 | 39 |
| Example | 57 | 35 |

FIG. 3 shows results of measurement of oxygen reduction reaction (ORR) activity of Example and Comparative Example according to the present disclosure. Referring thereto, the half-wave potential difference was measured to be 39 mV in Comparative Example and to be 35 mV in Example. The mass activity reduction rate (%) was smaller in Example, and the reduction rate in Example was about ¼ compared to Comparative Example, confirming that the electrodes according to Example includes the polymer according to the present disclosure and thus has an anti-poisoning effect in a phosphoric acid electrolyte environment.

As is apparent from the above description, a fuel cell according to the present disclosure includes a polymer containing a phosphoric acid group and a binaphthyl group, thereby preventing phosphoric acid poisoning of the catalyst due to strong interaction with phosphoric acid and porosity and increasing electrochemical performance.

The effects of the present disclosure are not limited to the above-mentioned effects. It should be understood that the effects of the present disclosure include all effects that can be inferred from the description of the present disclosure.

Although embodiments of the present disclosure have been described, those skilled in the art will appreciate that the present disclosure may be embodied in other specific forms without changing the technical spirit or essential features thereof. Thus, the embodiments described above should be understood to be non-limiting and illustrative in every way.

What is claimed is:

1. A polymer electrolyte membrane fuel cell, comprising:
an electrolyte membrane; and
electrodes comprising a cathode disposed on one side of the electrolyte membrane and an anode disposed on another side of the electrolyte membrane,
wherein the electrodes comprise a catalyst, an ionomer, and a polymer comprising a binaphthyl functional group.

2. The polymer electrolyte membrane fuel cell of claim 1, wherein the polymer is represented by Chemical Formula 1 below: 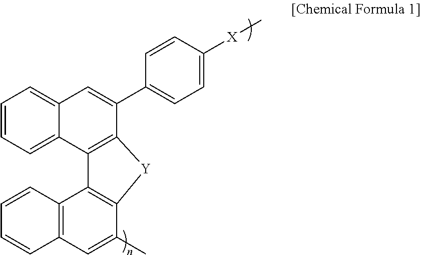
in Chemical Formula 1, X comprises a C6-C20 aromatic functional group, Y comprises a cation exchange group, and n is an integer of 5 to 1000.

3. The polymer electrolyte membrane fuel cell of claim 2, wherein the aromatic functional group is represented by Chemical Formula 2 below: 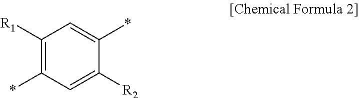
in Chemical Formula 2, * represents a connection site, and R₁ and R₂ each independently comprise a substituted or unsubstituted C1-C20 alkoxy group or perfluoroalkoxy group.

4. The polymer electrolyte membrane fuel cell of claim 2, wherein the cation exchange group comprises at least one selected from the group consisting of a sulfonic acid group, a carboxyl group, a phosphoric acid group, an imide group, a sulfonimide group, a sulfonamide group, a hydroxyl group, and combinations thereof.

5. The polymer electrolyte membrane fuel cell of claim 4, wherein the cation exchange group is a phosphoric acid group.

6. The polymer electrolyte membrane fuel cell of claim 1, wherein the polymer is represented by Chemical Formula 3 below: 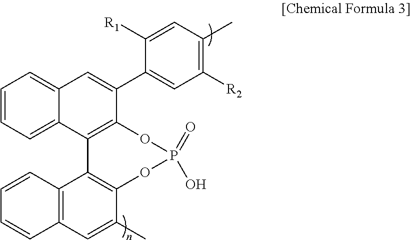
in Chemical Formula 3, R₁ and R₂ each independently comprise a substituted or unsubstituted C1-C20 alkoxy group or perfluoroalkoxy group, and n is an integer of 5 to 1000.

7. The polymer electrolyte membrane fuel cell of claim 1, wherein the polymer is attached to a surface of the catalyst.

8. The polymer electrolyte membrane fuel cell of claim 1, wherein the catalyst comprises at least one selected from the group consisting of platinum, palladium, cobalt, gold, ruthenium, tin, molybdenum, rhodium, iridium, bismuth, copper, yttrium, and chromium.

9. The polymer electrolyte membrane fuel cell of claim 8, wherein the catalyst is platinum.

10. The polymer electrolyte membrane fuel cell of claim 1, wherein the ionomer comprises at least one selected from the group consisting of a perfluorosulfonic acid polymer, a hydrocarbon-based polymer, and a polybenzimidazole polymer.

11. A polymer electrolyte membrane fuel cell, comprising:
an electrode
comprising a catalyst and a polymer attached to a surface of the catalyst,
wherein the polymer is represented by Chemical Formula 1 below: 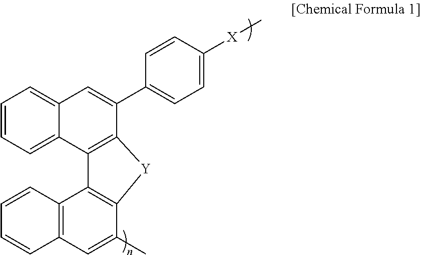
in Chemical Formula 1, X comprises a C6-C20 aromatic functional group, Y comprises a cation exchange group, and n is an integer of 5 to 1000,
wherein Y comprises at least one selected from the group consisting of a sulfonic acid group, a carboxyl group, a phosphoric acid group, an imide group, a sulfonimide group, a sulfonamide group, a hydroxyl group, and combinations thereof,
wherein the aromatic functional group is represented by Chemical Formula 2 below: 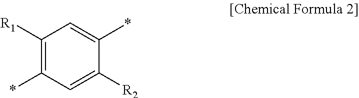
in Chemical Formula 2, * represents a connection site, and R₁ and R₂ each independently comprise a substituted or unsubstituted C1-C20 alkoxy group or perfluoroalkoxy group.

12. The polymer electrolyte membrane fuel cell of claim 11, wherein the catalyst comprises at least one selected from the group consisting of platinum, palladium, cobalt, gold, ruthenium, tin, molybdenum, rhodium, iridium, bismuth, copper, yttrium, and chromium.

13. A method of manufacturing a polymer electrolyte membrane fuel cell, comprising:
preparing a polymer having a binaphthyl functional group;
manufacturing electrodes comprising a catalyst, an ionomer, and the polymer; and
stacking the electrodes on respective opposite sides of an electrolyte membrane.

14. The method of claim 13, wherein preparing the polymer comprises:
preparing compound B represented by Chemical Formula 5 below by subjecting compound A represented by Chemical Formula 4 below to Suzuki-Miyaura reaction;
preparing compound C represented by Chemical Formula 6 below by subjecting compound B to demethylation reaction; and
preparing a polymer represented by Chemical Formula 7 below by subjecting compound C to nucleophilic substitution reaction: 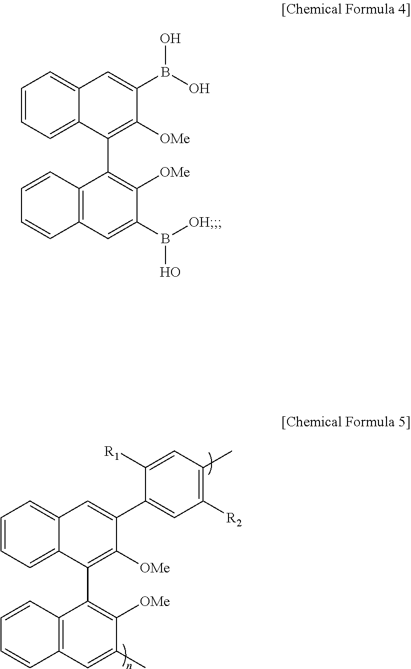
in Chemical Formula 5, R₁ and R₂ each independently comprise a substituted or unsubstituted C1-C20 alkoxy group or perfluoroalkoxy group, and n is an integer from 5 to 1000; 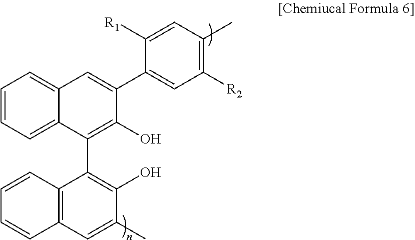
in Chemical Formula 6, R₁ and R₂ each independently comprise a substituted or unsubstituted C1-C20 alkoxy group or perfluoroalkoxy group, and n is an integer of 5 to 1000; and 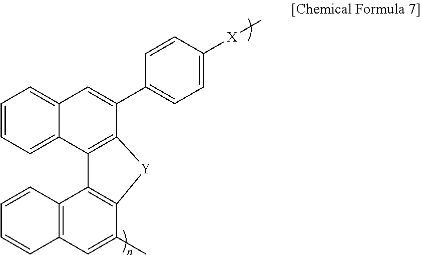
in Chemical Formula 7, X comprises a C6-C20 aromatic functional group, Y comprises a cation exchange group, and n is an integer of 5 to 1000.

15. The method of claim 14, wherein in the Suzuki-Miyaura reaction, compound A reacts with 2,5-dialkoxy-1,4-dibromobenzene to result in compound B.

16. The method of claim 14, wherein in the nucleophilic substitution reaction, compound C react with phosphoryl chloride (POCl₃) to result in the polymer represented by Chemical Formula 7.

17. The method of claim 14, wherein the aromatic functional group is represented by Chemical Formula 8 below: 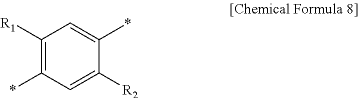
in Chemical Formula 8, * represents a connection site, and R₁ and R₂ each independently comprise a substituted or unsubstituted C1-C20 alkoxy group or perfluoroalkoxy group.

18. The method of claim 14, wherein the cation exchange group comprises at least one selected from the group consisting of a sulfonic acid group, a carboxyl group, a phosphoric acid group, an imide group, a sulfonimide group, a sulfonamide group, a hydroxyl group, and combinations thereof.

19. The method of claim 13, wherein the polymer is represented by Chemical Formula 9 below: 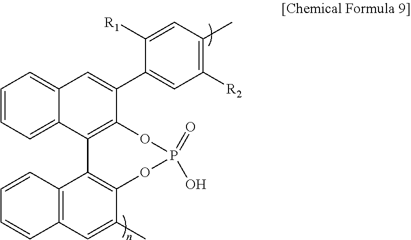
in Chemical Formula 9, R₁ and R₂ each independently comprise a substituted or unsubstituted C1-C20 alkoxy group or perfluoroalkoxy group, and n is an integer of 5 to 1000.

20. The method of claim 13, wherein the polymer is attached to a surface of the catalyst.
